(19) United States
(12) Patent Application Publication
(10) Pub. No.: US 2011/0161802 A1
(43) Pub. Date: Jun. 30, 2011

(54) Methods, processes and systems for centralized rich media content creation, custimization, and distributed presentation

(76) Inventors: Hongzhong Jia, Cupertino, CA (US); Yunfei Zhang, Beijing (CN); Chaojun Yin, Beijing (CN); Hao Chen, Beijing (CN); Zengqiang Du, Beijing (CN); Ming Tan Du, Beijing (CN); Yaping Liu, Sunnyvale, CA (US); Jonathan Jiang, Sunnyvale, CA (US)

(21) Appl. No.: 12/655,556

(22) Filed: Dec. 31, 2009

(51) Int. Cl. G06F 17/24

(52) U.S. Cl. 715/235

(57) ABSTRACT

The present invention is related to methods, processes, and systems that enable web users to quickly create, customize, and publish rich media contents via Internet. Web addresses and attributes with regard to the published rich media contents are also generated. The published rich media contents, web addresses and attributes are stored locally in a centralized place, but they can be called by any geographically distributed third-party websites or remote web users, and then be presented on the third-party websites or the terminal devices of the remote web users. Furthermore, the present invention also enables web users to quickly create and customize personal online stores at a centralized place, and then list the published rich media contents in their personal online stores. These listed rich media contents can also be referenced and called by any geographically distributed third-party websites or remote web users, and then be presented on the third-party websites or the terminal devices of the remote web users.

### BACKGROUND OF THE INVENTION

There is a fast growing trend for various consumer, commercial, and enterprise products to be sold via Internet in the past years and in the forthcoming future. Numerous companies, which are specialized on online merchandise sales, have appeared such as EBAY and AMAZON. In addition, manufacturers and companies that used to traditionally showcase and sell products through physical stores (e.g. department stores) have also put tremendous efforts to create online showrooms and stores to provide buyers online-shopping convenience. There are, however, major drawbacks for online shopping. First, without physical view of the products, buyers are not able to understand and feel the products with hands-on experiences. Second, most online stores only present products with photos in different perspectives (e.g. front, back, side, top, bottom, etc). These photos are not rich, tempting and cosmetically attractive. They do not provide buyers with an aesthetical presentation which can be easily achieved by traditional physical stores or showrooms.

The drawbacks associated with the online stores to a great extent dis-incentivize the buyers to purchase the products via online stores. Many online stores have realized these problems and they tried to solve the problems by developing rich media content display technologies with different aesthetical effects. However, the development process of these technologies is very time-consuming and expensive. Worse yet, the technologies are often only exclusively applicable to a limited number of online stores that happen to be compatible to these technologies. The intransitivity and less applicability of the technologies result in redundant development efforts and inconsistent user experience, since various online stores need to develop their own rich media content display technologies that serve similar purposes.

With rapid growth of online sales trend, there is no doubt that various manufacturers and companies will put more focus on developing user-friendly online stores with products presented in forms of rich media contents. There is a need that reusable, customizable, adaptable product rendering and presentation methods, processes and systems can be developed and invented so that different online stores can easily adopt. These methods, processes and systems need to provide templates, tools and web storages for users to create, edit and store rich media contents for their merchandises. In addition, they need to provide means for the rich media contents to be called by and presented on various online store websites. Better yet, they are able to provide a centralized host service, in which various companies and manufacturers not only can access and login to create and edit the rich media contents, but also can develop/open their online stores in the said host service system, and render/present the created rich media contents in the online stores.

The products for sales of a manufacturer may have many retailers, and these retailers may have their own online stores. With such a centralized host service system in place and with all the rich media contents of the products created and stored by the manufacturers in said system, the retailers can simply call the rich media contents and render them on their own online stores. This “created once in a centralized place, and used by many in distributed places” service system avoids redundant efforts for various online stores to re-create multiple times of the rich media contents as well as the associated technologies. It can also avoid inconsistent presentations in various online stores for the same products.

In this invention, methods, processes, and systems are developed to overcome the above-mentioned drawbacks associated with the traditional online stores. The invention facilitates the creation, customization, and publication of re-usable rich media contents, which are stored in a centralized place but can be called by and rendered on various online web stores via Internet. The invention also provides a platform to connect the manufacturers with the retailers via Internet so that the rich media contents of the products can be created once by the manufacturers, but can be used consistently by various retailers and other interested parties.

### SUMMARY OF INVENTION

In an implementation, a web host service system is created. In the said web host service system, rich media content templates are pre-designed and pre-stored using digital media tools. The digital media tools include any applications that can create digital media such as Flash, sliver-light, Java, Ajax, etc. Examples of the rich media content templates include any forms of icons, tags, animations, pictures, images, albums, showcases, show rooms, display boards/bulletins, show windows, natural backgrounds or foregrounds. Various visual and sound effects can be designed for the templates. The rich media content templates are stored in the web host service system.

In an implementation, a web user can access the web host service system to browse the rich media content templates. The web user can subscribe the service, create accounts, and add selected rich media content templates into his accounts. A set of rich media editing tools are provided in the service system, the user can edit/customize the templates in his accounts using these tools based his preference.

In an implementation, a service engine is designed and available in the web host service system. The engine provides various functions including interfacing and facilitating other applications to interact with the rich media content templates. The said other applications include local applications on the said web host service system or the applications on remote third-party websites/web servers.

In an implementation, a web user can upload pictures and/or other forms of media which describe the products he wants to display onto the web host service system or onto other remote website servers where the users want to display the products. From where the user has uploaded the product pictures/media, the user can call the rich media content templates stored on the said web host service system. The uploaded pictures and/or other forms of media can be merged into any selected rich media content template in web host service system. The user can change the selected template or edit/customize the template for different product rendering/presentation preferences. Furthermore, the user can save and publish the merged rich-media content in his account for public access via Internet. A web address code is generated through which public can access and view the published rich media contents stored in the web host service system through standard web protocol. A user can embed the address code into other web pages for public access. When the said other web pages are accessed by a web user through any terminal device via Internet, the address code will be referenced and the corresponding rich media contents will be called from the web host service System and rendered on the web user's terminal device.

In an implementation, a web user (e.g. a manufacturer representative) can access the web host service system and create an online store. The online store web page templates are pre-designed and stored in the web host service system. The user can select and edit a (or a set of) webpage template(s) to build their online stores, or they can start from beginning to design their personalized web page for their online stores. The user can upload visual and audio media that are associated to their products and merge them with the rich media content templates in the web host service system. They can then publish the merged rich media contents, embed and display the merged rich media contents in the webpages of their online stores for public access. Each published rich media content has an address code which can be called by and embedded into any third-party web page (e.g. a retailer's online store web page). As such, the rich media content can also be displayed in third-party websites and accessed by the public when the third-party websites are accessed by the public via Internet.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there are shown in the drawings example constructions of the embodiments; however, the embodiments are not limited to the specific methods, processes, systems and instrumentalities disclosed. In the drawings:

FIG. 1 is a block diagram of an implementation of a web host service system comprising web servers and storage nodes. The relationship among web users, third-party online stores, and the said web host service system is also illustrated.

FIG. 2 is a block diagram of an implementation of a web host service system comprising web servers and storage servers. An embodiment of the said web servers and an embodiment of the said storage nodes are depicted in the block diagram.

FIG. 3 is an operational flow of an implementation of a process and a method of web users accessing a web server in the web host service system without login, and going through the instruction guide, during which, the users can make a number of trial operations, including browsing rich media content library, editing selected rich media content in the library, uploading personal media, merging uploaded media with selected media in the library and, publishing/reviewing the merged media.

FIG. 4 is an operational flow of an implementation of a method of web users accessing a web server in the web host service system with login. If the login verification fails, the user can go through the instruction guide and make trail operations, as described in FIG. 3. Furthermore, the user can sign up for an account with an account folder created in a storage node of the web host service system. If the login verification is successful, the user will then be able to execute more actions provided by the web host service system, including browsing the media library, editing selected media, uploading personal media, merging uploaded media with selected rich media content in the library, saving merged media, and publishing merged media.

FIG. 5 is a flow diagram of the process of user logging in to a third-party website and then connecting to the web host service system of the present invention to retrieve published media and render them on the third-party website.

FIG. 6 is a flow diagram of the process of the rich media contents being called by third-party websites or by terminal devices of the web users and the rich media contents being sent to the third-party website or the terminal devices of the web users for rendering.

FIG. 7 is a flow diagram of the process of the web users logging into the web host service system of the present invention, creating and editing their personal online stores, retrieving published rich content media in the said web host service system, and embedding/rendering them in the webpages of the web users' online stores in the web host service system.

FIG. 8 shows an exemplary computing environment.

### DETAILED DESCRIPTION OF INVENTION

The present invention embodies methods, processes and systems to allow web users to create customized rich-media contents that can be called by and embedded in other third-party websites for public access. Furthermore, the present invention embodies methods, processes and systems to allow web users to build customized online stores in a centralized web host service system and render the rich media contents in their online stores in the said centralized web host service system. The rich media contents in the centralized web host service system can be called by and embedded in other third-party websites for public access.

In a specific embodiment of the present invention, a number of rich media content templates are pre-designed and stored in a media template library in a web host service system, which consists of a number of web servers and local or remote storage nodes. A variety of, tools are available in the web host service system for web users to customize any selected template based on each user's preference. The customization includes the adjustment of both/either visual and/or sound effects. The visual effect adjustment includes, but is not limited to, changing the color, contrast, background, foreground, adding/removing animation, and increasing/decreasing size. The sound effect adjustment includes, but is not limited to, changing the audio clips, adding/removing the audio clips, modifying bass/triple effects, and changing the volume/pace. After the template customization is completed, web users can save the new template in their personal account folders in the web host service system for future use.

In a specific embodiment of the present invention, a web user can log into the web host service of the present invention, and upload personal images and sound clips into his account folder. The user can merge the uploaded images and sound clips with the selected rich media content template in the library or the selected customized rich media content template his personal account folder. The merged rich-media contents can be saved in the user's account folder.

In a specific embodiment, a user can log into the web host service system of the present invention, browse the merged rich-media contents in his account folder, and then publish them. A web address code will be generated by the system of the present invention for each published rich media content. This web address code can be called by and embedded in any web page for public access.

There are various ways for the systems, methods and processes of the present invention to be used to render the rich media contents on various online store websites. In a specific embodiment, the present invention provides web users means to log into the web host service system, create online stores on a local server of the said system and then put the address codes of the published rich media contents into the web pages of their online stores. When the web pages are accessed by the public, the rich media contents will be called and rendered in the user's online stores. In another specific embodiment, a web user can log into his online store account on a third-party website such as www.ebay.com or www.amazon.com (not in the said web host service system). He can fetch the published rich media contents in the web host service system of the present invention and then embed the corresponding address codes onto the web pages of his online store account on the third-party website. When the web pages of the user's online store on the third-party website are accessed by the public, the web host service system of the present invention provides a method for the rich media contents to be called, sent and rendered on the users' online stores on the third-party website.

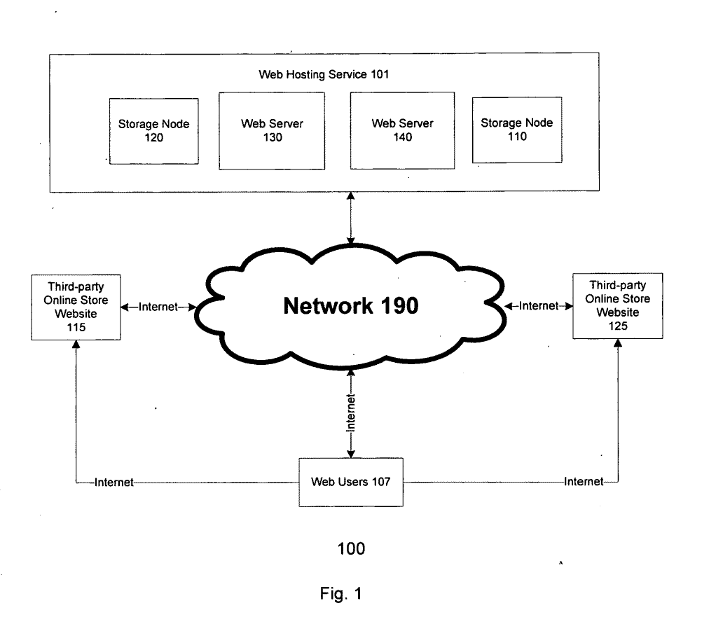

FIG. 1 is a block diagram of an implementation of a web host service system 101 comprising distributed web servers 130, 140 and storage nodes 110, 120. The storage nodes 110, 120 can be any storage devices such as hard drives that are directly attached to the web servers 130, 140. Alternatively, the storage nodes 110, 120 can be remote storage devices or servers that are connected through a network to the web servers 130, 140. The web host service system 101 is connected to a network 190, such as a local area network (LAN), or wide area network (WAN), and then further connected to other various third-party online store websites 115, 125 and web users 107 via Internet. Web users 107 can access various third-party online stores 115, 125, or the network 190 and then the web host service 101 via Internet.

In the embodied web host service system 101, although only two web servers 130, 140 and two storage nodes 110, 120 are shown in FIG. 1, any number of web servers and local/remote storage nodes can be used. Furthermore, other various computing devices such as data processors and networking devices can be used in the web host service system 101. In addition, only two third-party online store websites 115, 125 are shown in FIG. 1. However, any number of third-party online store websites can be connected to the network 190 and access the web host service system 101.

For web users 107, they can be located at any geographically distributed places. They may use one or more terminal hardware devices such as PCs, MACs, or mobile devices such as cell phones, netbooks or notebooks, as well as any applicable terminal software such as Microsoft Internet Explorer, Google Chrome, or Firefox to connect to the network 190 and then access the web host service system 101.

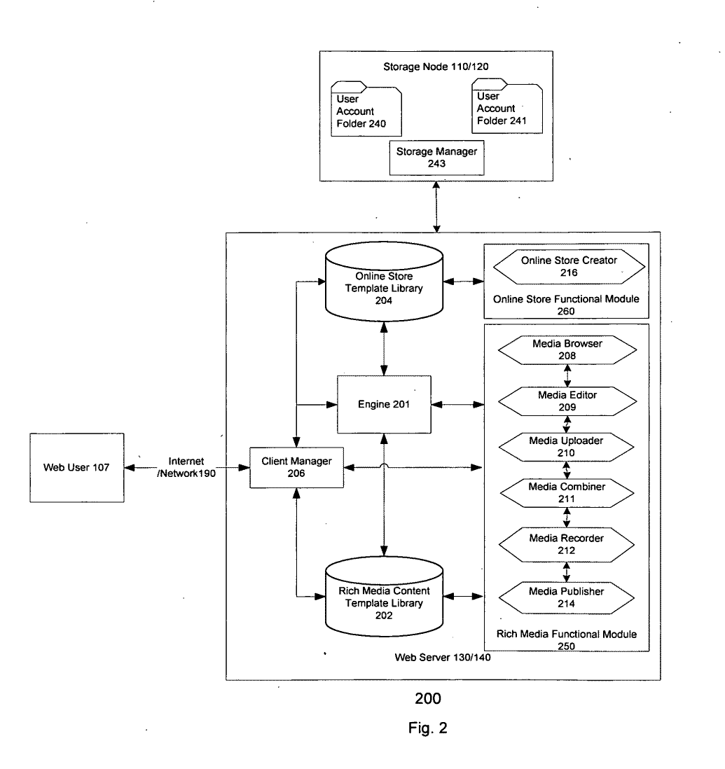

FIG. 2 shows a block diagram for a specific embodiment of the web host service system 200 with detailed components listed in the storage nodes 110, 120 and in the web servers 130, 140.

In this embodiment, each storage node 110 or 120 consists of a storage manager 243 and user account folders 240, 241. Each user account folder 240 or 241 includes a dedicated physical storage to store the user's miscellaneous data and files. The storage manager 243 is responsible for creating, removing and managing the user's account folder and the data/files in the folder. It also provides different functions to the user account folder, including, but is not limited to, storage quota management, user data/file permission management, user file uploading/downloading services, user accounts creation, moving, and removing, and the communication management between the storage node 110 or 120 and the web servers 130, 140.

Although there are only two user account folders 240, 241 shown in the storage nodes 110, 120, there can be any number of user account folders in each storage node. Also a user account folder can be, but do not have to be, independent or exclusive from one other. It is permissible that a number of user account folders share a common part of storage and all the folders have access to the shared storage. It is also permissible that one user account folder is a subset or a superset of another user account folder. Furthermore, in the embodiment described in FIG. 2, the storage manager 243 is shown as an individual and integrated component. It can, however, be divided into separate elements, each of which is responsible for a different and specific functionality.

Each web server 130 or 140 in this embodiment comprises a client manager 206, an engine 201, a rich media template library 202, a rich media functional module 250, an online store template library 204 and an online store functional module 260.

The client manager 206 coordinates the logistics and communication between the web users 107 and the web servers 130, 140. It provides various functions such as user sign-up, user login, user verification, and concurrent real-time user connections. It also provides the directory service for the users and connects the users to their corresponding user account folders in the storage nodes 110, 120.

The rich media content template library 202 consists of pre-designed rich media contents including various forms of visual files and/or sound clips. The visual files include, but not limited to, any forms of icons and tags, animations, pictures, images, albums, showcases, show rooms, show windows, natural backgrounds or foregrounds. The sound clips can be any forms of sound tracks. The rich media contents in the library can be, but do not have to be, categorized based on different criteria such as names, sizes, and functions.

The online store template library 204 consists of pre-design web page templates and configurations for web users to quickly create online stores on the web host service system 200. When a web user logs into the web host service system 200, he can browse the library 204 and select a web page template. The online store creator 216 of the online store functional module 260 provides the user functions to create the online store and set up the configuration. The client manager 206 will record the users who have created online stores. The web page files and the configuration files of the user's online store will be saved in the user' account folder in the storage node 110, 120.

The engine 201 provides functions for the users to search the wanted rich media content template in the library 202 and the wanted online store template in the library 204. It also provides functions for a user to search his data/files or other users in the account folders 240, 241 in the storage nodes 110, 120. In addition, the engine 201 provides connection and protocol support to respond the requests from remote websites or web users on fetching the data and files on the web host service system 200 and deliver the data and files back to the remote websites and web users.

The rich media functional module 250 in this embodiment consist of a media browser 208, a media editor 209, a media uploader 210, a media combiner 211, a media recorder 212, and a media publisher 214. The media browser 208 provides functions for a web user to browse the rich media contents in the template library 202 and online store templates in library 204. It is possible that the engine 201 is used first to search the wanted rich media contents in the template library 202 and the wanted online store templates in library 204, and then the media browser 208 is used to browse the search results of the rich media content templates and the online store templates.

When media browser 208 is used to browse the rich media contents, a rich media content of interest can be selected. The media editor 209 provides functions and tools for users to customize the selected rich media content. The customization includes the adjustment of visual and/or sound effects. The visual effect adjustment includes, but is not limited to, changing color, contrast, background, or foreground, adding/removing animations, and increasing/decreasing size, changing the combination of the images, icons, tags. The sound effect adjustment includes, but is not limited to, changing the audio clips, adding/removing the audio clips, modifying bass/triple effects, and changing the volume/pace. After the adjustment is completed, the media editor 209 also makes the connections with the storage manager 243 for the user to store the customized rich media contents as new templates in his corresponding user account folder 240 or 241.

The media uploader 210 provides functions and tools for a web user to upload his personal visual media files and audio media files onto the web servers. Upon uploaded, the media editor 209 can be selectively used to edit the uploaded visual files and audio files. After the user's personal visual files and audio files have been uploaded with necessary editing, the media combiner 211 can be used to merge the uploaded visual and audio files with any selected rich media content in the template library 202 or any selected customized rich media contents in the user's corresponding user account folder 240 or 241 in the storage node 110, 120.

The processes of editing the personal uploaded media files or the pre-designed rich media content in template library 202, and the merging of the personal media files with the rich media content in the template library 202 or the user account folder can be recorded by the media recorder 212. A script is generated that is a text or binary log file of the processes of the editing and merging. User can apply this script to automate the editing and merging of the newly uploaded personal media files and the rich media contents in the template library 202 or in the user account folder 240 or 241.

After the web user's personal visual files and audio files have been uploaded, edited and merged with the selected rich media content in the template library 202 or the user account folder 240 or 241, the media publisher 214 can be used to publish the merged rich media content. Upon publication, the merged rich media content will be stored into the corresponding user account folder 240 or 241 in the storage node 110, 120. Furthermore, an address code will be generated that is a unique web identification to the published rich media content stored in the client account 240, 241. The media publisher 214 can also be used to set the necessary permission for the published rich media contents. Private permission only allows one user, namely the owner of the published rich media content to access it through the address code. Limited permission allows one or several designated users or groups to access it through the address code. Public permission allows any web users to access it through the address code. The address code can be pasted into a terminal device's web browser and directly rendered on the terminal device's web browser. Alternatively, the address code can be embedded into a third-party webpage and when the webpage is accessed by a terminal device's web browser, the requests will be responded by the engine 201 and the rich media will be delivered and rendered along with the third-party webpage on the terminal device's web browser.

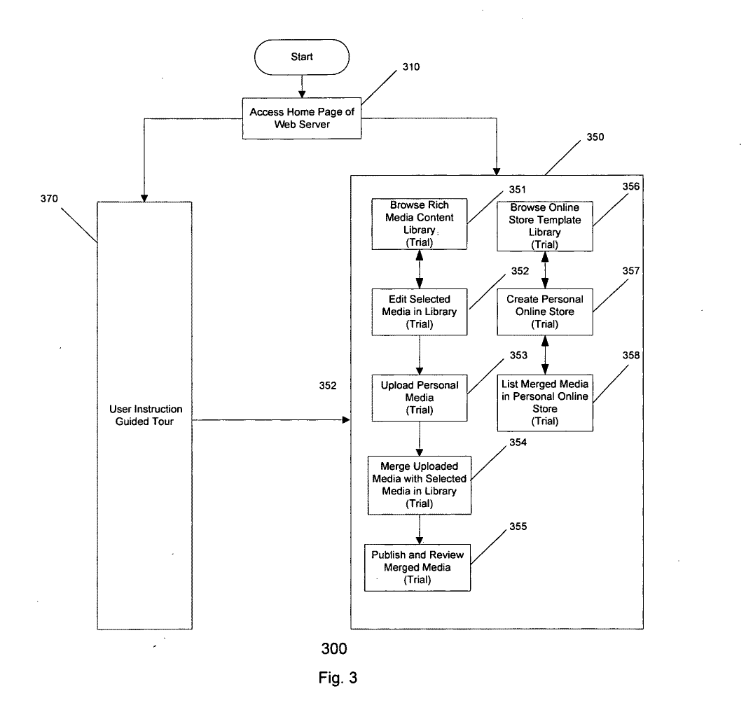

FIG. 3 illustrates a process and a method for the web host service system 200 of the present invention to provide functions for web users to access the services without logins. At 310, a web user can use a terminal device to access the web servers of the web host service system 200 via Internet. In an embodiment, the access connection can be achieved by using a web browser of the web user's terminal device to access the home page of the web host service system 200 via Internet.

Upon accessing the web server, at 350, without login, a web user can preview various web pages that include different functions provided by the web host service system 200. The web user can look into the web pages and try these functions. At 351, the user can browse various pre-designed rich media contents in the template library 202. At 352, the user can try to edit/customize a selected rich media contents. Since the user has not logged into the web host service system 200, the user will be reminded that the editing and customization are trials and cannot be saved. At 353, the user can try to upload their personal visual or audio files onto the web host service system 200. The uploaded files will be displayed or placed in a web page window especially for personal uploaded files. At 354, the user can try to merge the uploaded visual and/or audio files with the selected rich media contents in the template library 202. At 355, the user can try to publish and review the merged rich media content. A temporary web address code is generated for the merged rich media content. In an implementation of the review process, the user will be shown with a web page with information stating that the merged rich media contents can be stored in the web host service system 200 if the user has logined into the system. The user will also be shown with a web page stating that if the generated web address code is stored in the system, it can be embedded into other web pages, which can be accessed by different web users through their terminal devices via Internet. At 356, the user can browse various online store templates in the library 204. At 357, the user can try to select an online store template in the library 204 to create a personal online store. At 358, the user can put the temporary web address code of the merged rich media content into a web page of the personal online store. The user can view the rich media content listed in his personal online store. Since the user has not logged into the web host service system 200, the user will be reminded that the online store creation and the rich media content listing are trials only and cannot be saved.

When a user accesses the web servers, previews and tries different functions, the user can, at 370, take a user instruction guided tour. In an implementation, the user instruction guided tour is shown as web pages with a pre-designed graphical step-by-step animation with acoustic explanation that instructs the user how to browse the template library, edit selected rich media content, upload the user's′ personal files, merge the personal files with the selected rich media content in the template library, publish the merged media content, browse online store template library, create personal online store and list merged media content in the personal online store.

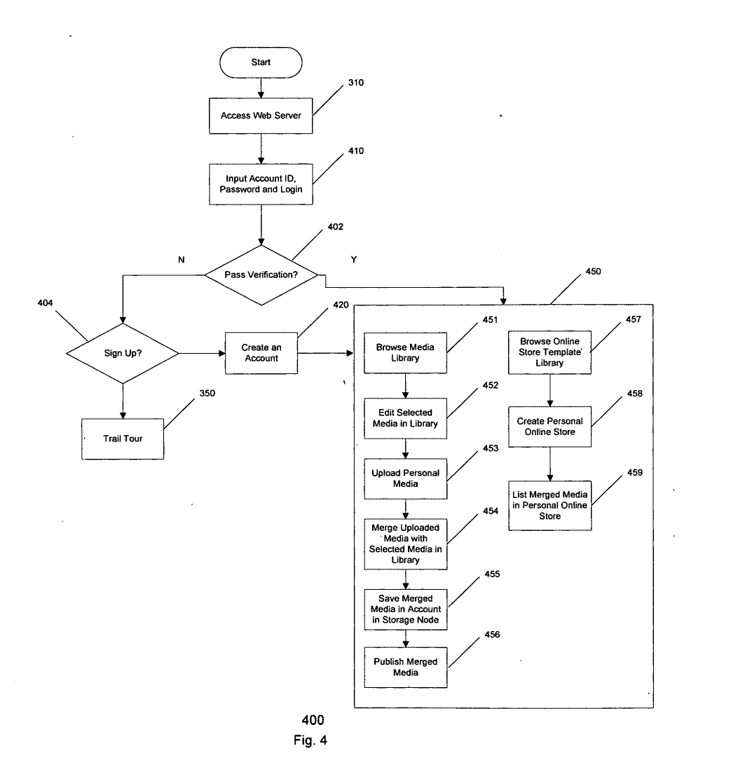

FIG. 4 illustrates a process and a method for the web host service system 200 of the present invention to provide functions for user to access the system with signup or login. At 310, a web user can use a terminal device to access a web server of the web host service system 200 via Internet. At 410, the web user needs to provide an account name and a password to login the system. In an implementation, upon the user accessing to the web server of the web host service system 200, an introduction web page is shown to the user with text boxes for the user to input the account name and the password in order to enter the web host service system 200. At 402, a verification process is conducted to check the legitimacy of the account name and the password. If the inputs match the records in the system, the login will pass and the user can then enter the web host service system 200 and start other processes to use the system.

If the verification process fails, the user will be reminded to sign up for the web host service system 200. In an implementation, the user is guided into a new web page where the user can input required information and sign up for the web host service system 200. If the user selects to sign up, he needs to input all the required information for the system to identify him as a new user. Upon sign-up, at 420, a user account will be created in the web host service system 200. In an implementation, a user account entry directory will be created in the client manager 206 in the web server with all the user's information stored. In addition, a user account folder will be created by the storage manager 243 in the storage nodes. If the user chooses not to sign up, at 350, he can take the guided tour and make function trials as previously described in FIG. 3.

After a user has signed up and a user account has been created, at 450, the user can perform various actions on the rich media contents and online store templates. Since the user has logged into the system, the actions to be perform are not trials.

At 451, the user can browse various pre-designed rich media contents in the rich media content template library 202. The function in this process is provided and supported by the media browser 208. In an implementation, a browsing window will be shown in a web page to the user and the user can scroll down/up the window to view the list of available rich media contents. The user can zoom in and out of a rich media content in the window. At 452, the user can edit/customize a selected rich media content in the template library 202. The function in this process is provided and supported by the media editor 209. The editing and customization include the adjustment of visual and/or sound effects. In an implementation, the visual effect adjustment includes, but is not limited to, changing color, contrast, background, or foreground, adding/removing animations, increasing/decreasing size, and changing the combination of the images, icons, or tags. In an implementation, the sound effect adjustment includes, but is not limited to, changing the audio clips, adding/removing the audio clips, modifying bass/triple effects, and changing the volume/pace. In an implementation, the customized rich media contents are saved into the user's corresponding account folder 240 or 241, located in the storage nodes 110, 120.

At 453, the user can upload his personal media files including visual and audio files onto a web server of the present invention. The function in this process is provided and supported by the media uploader 210. In an implementation, the media uploader provides a web page with an uploading window to the user. Through the uploading window, the user can browse files in the terminal device on the user side. The user can select the target files and then upload them into the uploading window. Upon uploaded, the media editor 209 can be used to edit the uploaded visual files and audio files, as described at 452.

At 454, the users can combine the uploaded personal media, with necessary editing, with any selected pre-designed rich media content in the template library 202 or any customized rich media content in the user account folder 240, 241. The function in this process is provided and supported by the media combiner 211. In an implementation, the merged rich media content is shown in a web page window for user to review. Upon merged, the users can selectively edit the merged rich media content by using the function provided by the media editor 209, as described at 440.

At 455, the user can save the merged rich media content into his account folder 240 or 241 in the storage node 110 or 120. At 456, the user can publish the merged rich media content and set the permission for the published rich media content. The function in this process is provided and supported by media publisher 214. In an implementation, the publication involves the generation of a web address code and the setting of an access permission to the published rich media content. The web address code is a unique Internet address that can be called by other web users in order to access and view the published rich media content via Internet through a terminal device. The access permission sets the policy on what type of web users can access and view the published rich media content. In an implementation, three different permissions including private permission, limited permission, and public permission can be set. The private permission denotes that only the rich media content owner can access and view, upon providing an administrator password, the content through the web address code. The limited permission denotes that a number of designated users can access and view, upon providing a guest password, the content through the web address code. The public permission denotes that any user can access the content through the web address code. In an implementation, the publication also involves the generation of a web page. The web page consists of the published rich media content as well as other necessary descriptions related to the published rich media content that the user wants to provide to public when the web page is accessed via Internet. The said other necessary descriptions include, but are not limited to, product dimension, size, shipping method, technical specifications, warranty, prices, and conditions.

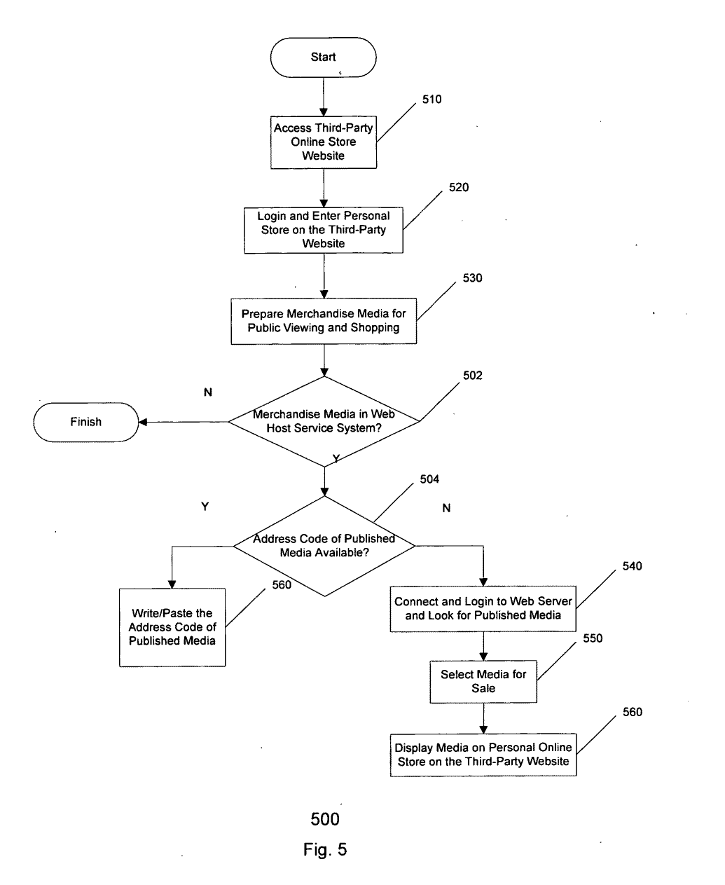

FIG. 5 illustrates a process of a web user using a third-party website to call the web address code of a published rich media content in the web host service system 200 and render the rich media content in his personal online store in the third-party web site. At 510, the web user accesses the third-party website via Internet. At 520, the web user logs into and enters his personal online store on the third-party website. At 530, the web user makes necessary logistical preparation, as needed by the third-party website, for the merchandise media to be listed and viewed on his personal online store on the third-party website.

At 502, the web user decides if the merchandise to be listed is saved as a rich media content in the web host service system 200 of the present invention. If the merchandise is not saved as a rich media content in the web host service system 200, then no connection needs to be made between the third-party website and the web host service system 200. The process is finished. If the merchandise to be listed is saved as a rich media content in the web host service system 200, then at 504, the user will need to continue to the next step depending on if the web address code of the rich media content of the merchandise is available. If the web address code of the published media is available, then at 570, the user can directly embed it into the web page of his personal online store in the third-party website. If the address code is not available, at 540, the user will need to connect and log into the web host service system 200 and browse the published rich media contents in his client account. At 550, the user selects the targeted rich media content that is associated to the merchandise he wants to list in his personal online store in the third-party website. At 560, the user copies the web address code of the targeted rich media content into the web page of his personal online store on the third-party website, in which the rich media content is displayed. The address code of the rich media content will be embedded into the web page of the user's online store in the third-party website. When the web page of the user's online store in the third-party website is accessed by the public via Internet, the rich media content will be called and rendered in the web page of the user's online store.

Displaying a rich media content on the web pages of the third-party online store is dependent on the permission setting to the rich media content by its owner in the web host service system 200. If the permission is set as private or limited, then either an administrator password or a guest password is required before the rich media content can be displayed on the web pages of the third-party online store. If the permission is set as public, then no password is required before the rich media content is displayed.

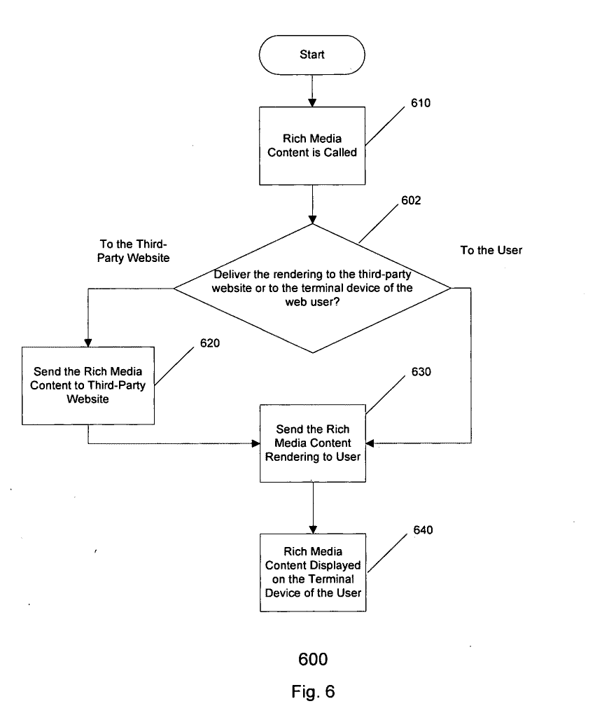

FIG. 6 illustrates a process and a method for the published rich media contents to be delivered and rendered from the web host service system 200 to the terminal device of a web user when the web user is accessing the rich media content. At 610, the rich media content is called. In an implementation, the call to the rich media content is achieved by standard Internet protocols such as HTTP, SOAP, RSS, and DAV. The initiators of the call can be a third-party website or a web user. At 602, a detection is made on if the call is from a third-party website or from a web user. If the rich media content is requested to be sent to third-party website, at 620, the web host service system 200 will deliver the rich media content to the third-party website via Internet. The delivery can be achieved in standard Internet protocols such as TCP/IP or UDP. If the rich media content is requested to be sent to a web user, at 630, the web host service system will deliver the rich media content to the terminal device on the user side. At 640, the rich media content will be rendered on the terminal device of the user.

The delivery and rendering of a rich media content on the web pages of the third-party online store or on the browser of the terminal device of a web user is also dependent on the permission setting to the rich media content by its owner in the web host service system 200. If the permission is set as private or limited, then either an administrator password or a guest password is required before the rich media content is delivered and rendered on the web pages of the third-party online store or on the browser of the terminal device on the user side. If the permission is set as public, then no password is required before the rich media content is delivered and rendered.

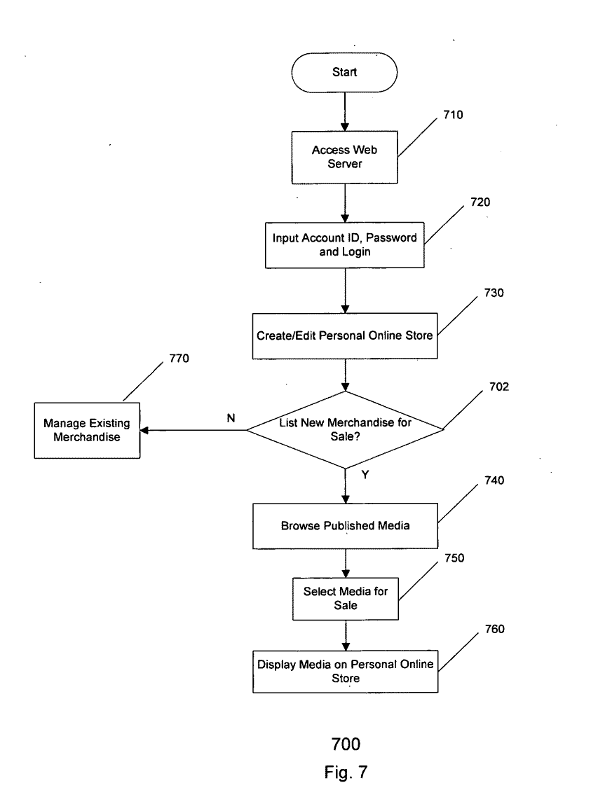

FIG. 7 illustrates a process and a method of a web user using the web host service system 200 of the present invention as a platform to create/edit an online store and list rich media contents in the online store. The third-party website is not required in this process since the user uses the web host server system 200, not a third-party website, as a platform to create/operate the online stores.

At 710, a web user accesses a web server of the web host service system 200 of the present invention via Internet. At 720, the web user inputs an account ID and a password to log into the system. Upon login, at 730, the user can create or edit his online store web page. In an implementation, standard online store web page templates will be pre-designed and saved in the online store template library 204 for the web user to quickly create their online stores. The user can select, configure and personalize a template. The personal and configuration settings are stored and managed by client manager 206. The files related to the online store web pages are stored in the user account folder 240 or 241 in the storage nodes 110, 120. In another implementation, the web user can upload self-designed web pages into the web host service system to create his online store. The files related to the self-designed online store web pages will be stored in the user account folder 240 or 241 in the storage nodes 110, 120.

If the user already has an online store in the web host service system 200, at 730, the web user can also edit the web pages of their online stores. User can change configurations and settings, change web page template, change the font and text, and adjust web page background and foreground.

At 702, the web user will decide if he wants to list a new merchandise in his online store web page. If not, at 770, the user manages existing merchandises in his online store web page. In an implementation, the user can delist the existing merchandises, change the rendering of the merchandises, and write descriptions/specifications on the merchandises. If the user decides to list new merchandise, he needs to browse the previously published rich media contents in his user account folder 240 or 241 in the storage nodes 110, 120. The media browser 208 provides the supports/functions for the rich media contents to be browsed. In an implementation, a browsing window will be shown to the user and the user can scroll down/up the window to view a list of the published rich media contents in his user account folder 240 or 241. The user can zoom in and out of a rich media content in the window to view the details of the rich media contents. At 750, the user will select a rich media content that is associated to the merchandise he wants to list in his online store. At 760, the address code of the rich media content will be passed onto and embedded in the web page of the online store. When the web page of the user's online store is accessed by public via Internet from terminal devices, the rich media contents associated to the merchandises are delivered and rendered along with the web page of his online store on the terminal device of the web users.

The delivery and rendering of a rich media content on the web pages of the online store on the browser of the terminal device of a web user is dependent on the permission setting to the rich media content by its owner in the web host service system 200. If the permission is set as private or limited, then either an administrator password or a guest password is required before the rich media content is delivered and rendered on the browser of the terminal device on the user side. If the permission is set as public, then no password is required before the rich media content is delivered and rendered.

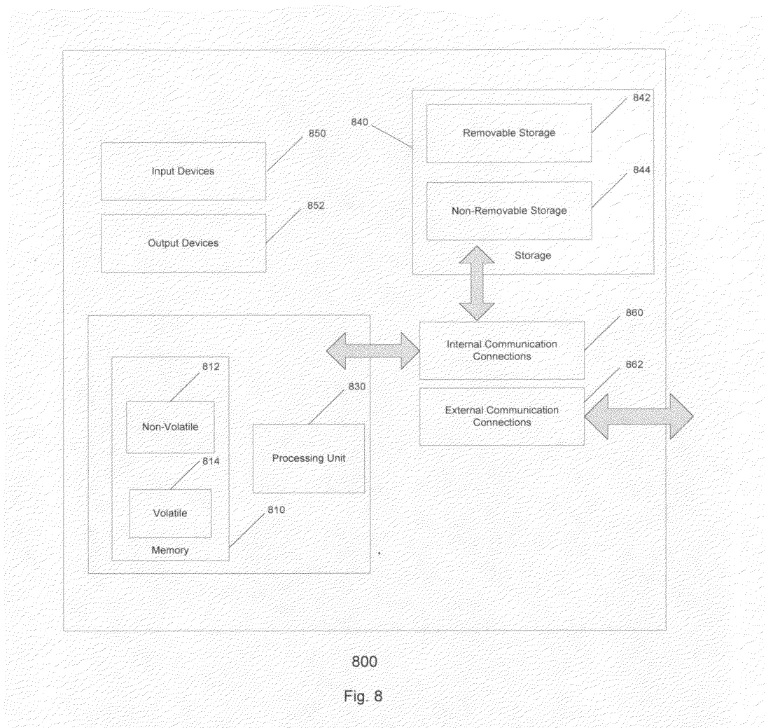

FIG. 8 shows an example of a computing environment of the web servers and storage nodes in the web host service system 200. The computing system environment is for exemplary purpose only and is not intended to suggest any limitation as to the scope of use or functionality.

A number of other computing system environments or configurations with either general purpose or special purpose may be used. Examples of well known computing systems, environments, and/or configurations include, but are not limited to, personal computers (PCs), server computers, handheld or laptop devices, multiprocessor systems, microprocessor-based systems, chip-powered storage, network PCs, minicomputers, mainframe computers, embedded systems, distributed computing environments that include any of the above systems or devices, and the like.

Computer-executable instructions, such as program modules and applications, that can be executed in a computing environment may be used. Program modules and applications include scripts, codes, procedures, threads, routines, programs, objects, components, data structures, etc. that can perform particular tasks or implement particular abstract data types. Distributed computing environments may be used in which tasks are performed in a distributed way by various remote processing devices that are connected through a network such as LAN or WAN. In a distributed computing environment, program modules, applications and other data types may be located in both local and remote storage media including, but are limited to, non-removable storage such as hard disk devices, solid state disk devices, memory storage devices, optical storage devices, and removable storage such as flash drive devices or tape devices.

In the most basic configuration, the computing device 800 includes at least one processing unit 830, memory 810, storage 840, internal communication connections 860, and external communication connections 862. The memory 810 may be of volatile type 812 (such as random access memory (RAM)), or non-volatile type 814 (such as read-only memory (ROM), flash memory, etc.), or a combination of the two. Storage 840 may be removable storage 842 or non removable storage 844, or a combination of the two. The type of storage can be hard disk devices, memory storage devices, optical storage devices, and removable storage such as flash drive devices or tape devices. Internal communication connections 860 provide functions to allow a component of the computing device 800 to communicate with other components. External communication connections 862 provide functions to allow the computing device 800 to make communication with external entities such as the Internet connections with third-party websites or with the terminal devices of the geographically distributed web users.

Computing device 800 typically includes various computer readable media. Computer readable media can be any available media that can be accessed by device 800 and include both volatile and non-volatile media, and removable and non-removable media.

Computer storage media include volatile and non-volatile, and removable and non-removable media implemented in any method or technology for storage of information such as computer readable instructions, data structures, program modules or other data. Memory 810, removable storage 842, and non-removable storage 844 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 800. Any such computer storage media may be part of computing device 800.

Computing device 800 may further have input devices 850 and output devices 852. The input devices 850 include, but are not limited to, a keyboard, mouse, pen, joystick, voice input device, touch input device, etc. The output devices 852 include, but are not limited to, monitors, speakers, printers, projectors, etc. All these devices are well known in the art and need not be discussed in details here.

Computing device 800 may be one of a number of computing devices 800 inter-connected by a network. The network may be any appropriate network such as LAN, WAN, etc., and each computing device 800 may communicate with one or more of the other computing devices 800 in the network in any appropriate manner through any appropriate network protocol. The network may be a wired or wireless network within an organization or home or in any remotely distributed manner, and may include a direct or indirect coupling to an external network such as the Internet or the like.

It should be understood that the various techniques described may be implemented in connection with hardware or software or, where appropriate, with a combination of both. Thus, the processes, methods, and systems of the present invention, or certain aspects or portions of the invention, may take the form of program codes/scripts/modules/applications (i.e., instructions) stored in tangible media, such as flash drives, CD-ROMs, hard drives, or any other machine-readable storage medium where, when the program codes/scripts/modules/applications are loaded into and executed by a or a group of machines, such as a number of computers, the machine(s) becomes an environment to perform the presently disclosed invention.

In the case of program code execution on programmable computers, the computing device generally includes a processor, a storage medium readable by the processor (including volatile and non-volatile memory and/or storage elements), internal communication connections, external communication connections, at least one input device, and at least one output device. One or more programs may implement or utilize the processes described in connection with the presently disclosed invention, e.g., through the use of an API, reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

Although exemplary implementations and embodiments may refer to utilizing aspects of the presently disclosed invention in the context of one or more stand-alone computer systems, the invention is not so limited, but rather may be implemented in connection with any computing environment, such as a network or distributed computing environment. Still further, aspects of the presently disclosed invention may be implemented in or across a number of processing chips or devices, and storage may similarly be affected across a number of devices. Such devices might include PCs, network servers, and handheld devices, for example.

Although the present invention has been described in terms of various implementations and embodiments, it is not intended that the invention be limited to these implementations and embodiments. Modification within the spirit of the invention will be apparent to those skilled in the art. For example, several components (e.g. media editor, media uploader, rich media content template library, online store template library), servers (e.g. web servers), or nodes (e.g. storage nodes) in the invention can be combined into a single component, server, or node to perform same, but integrated functions. Also, the steps for certain processes and methods may not necessarily be the same as described as in the implementations and embodiments and one skilled in the art would appreciate that the steps of the processes and methods can be adjusted and there will be no impact on the functions or the results of the invention.

Although the disclosed invention has been described in language specific to structural features and/or methodological functions, it is to be understood that the invention defined in the appended claims is not necessarily limited to the specific features or functions described above. Rather, the specific features and functions described above are disclosed as example forms of implementing the claims.

What is claimed:

1. A web host service method for creating and customizing rich media contents in a centralized system, and rendering and presenting said rich media contents via Internet at geographically distributed places, comprising:
creating user accounts, accessing user accounts, maintaining user profiles, and changing account settings;
allocating storage for user accounts, storing user account data, managing user account data, removing user account data, and removing user accounts;
providing a plurality of pre-designed rich media content templates; and
providing a plurality of tools for users to browse, edit, customize, upload, combine, review, and publish rich media contents.

2. The method of claim 1, further comprising providing an instruction and an interactive guided tour for web users to preview the functions of creating, editing, merging, reviewing, and publishing the rich media contents and make trials on said functions without creating accounts or logging into the system.

3. The method of claim 1, further comprising providing means for web users to search files and data in said rich media content template library and in their account folders.

4. The method of claim 1, further comprising:
providing means for responding requests from third-party website on fetching said published rich media contents from the user accounts and delivering said published rich media contents to said third-party website via Internet; and
providing means for responding requests from remote web users on fetching said published rich media contents from the user accounts, and delivering said published rich media contents to the terminal devices of said remote web users for rendering.

5. The method of claim 1, further comprising:
providing means for recording users' operations on said rich media contents as well as on said uploaded personal media files, including editing operations, customizing operations, merging operations, reviewing operations, and publishing operations;
providing means for generating recording scripts with regard to said users' operations; and
providing means for automatically repeating said users' operations on the rich media contents and on the uploaded personal media files, by executing said recording scripts;

6. The method of claim 1, further comprising generating web address code and attribute codes for said published rich media contents.

7. The method of claim 6, wherein the web address code comprises at least a unique URL address, and wherein the attribute codes comprise at least one of a listing date, a listing user, a specification, a warranty, a manufacturer, a shipping method, a shipping rate, and a contact method with regard to said published rich media contents.

8. The method of claim 6, further comprising:
providing responses to requests on fetching said web address code from third-party websites and delivering said web address code and the corresponding rich media contents to said third-party websites;
providing responses to requests on fetching said attribute codes from third-party websites and delivering said attribute codes to said third-party websites;
providing responses to requests on fetching said web address code from remote web users and delivering said web address code and the corresponding rich media contents to the terminal devices of said remote web users; and
providing responses to requests on fetching said attribute codes from remote web users and delivering said attribute codes to the terminal devices of said remote web users.

9. The method of claim 1, wherein the permissions comprise private permission, limited permission and public permission based on the levels of access and the types of access the owner of said published rich media contents wants to give to other third-party websites and web users.

10. The method of claim 1, wherein the pre-designed rich media content templates comprise:
visual media files with regard to icons and tags, animations, pictures, images, videos, digital albums, showcases, show rooms, show windows, and natural backgrounds or foregrounds;
acoustic media files with regard to various sound clips and tracks; and
combined visual media files and acoustic media files.

11. A web host service method for creating and customizing online stores in a centralized system and then listing the published rich media contents in said online stores in said system, comprising:
creating user accounts, accessing user accounts, maintaining user profiles, and changing account settings;
allocating storage for user accounts, storing user account data, managing user account data, removing user account data, and removing user accounts;
providing a plurality of pre-designed online store web page templates;
providing a plurality of online editing tools for users to browse, edit and customize said online store web page templates; and
providing means for users to upload their personal online store web pages.

12. The method of claim 11, further comprising providing means for users to list and manage the published rich media contents along with the attribute codes with regard to said published rich media contents in said personal online stores in said system;

13. The method of claim 11, further comprising providing an instruction and an interactive guided tour for web users to preview the functions of creating and editing said personal online stores and to make trials on said functions without creating accounts or logging into said system.

14. The method of claim 11, further comprising searching files in said online store template library and in the users' account folders, and then returning and displaying the search results.

15. The method of claim 11, further comprising:
providing means for responding requests from third-party websites on accessing said personal online stores and delivering said published rich media contents and the associated attribute codes to said third-party websites via Internet; and
providing means for responding requests from remote web users on accessing said personal online stores, and delivering said published rich media contents and the associated attribute codes to the terminal devices of said remote web users for rendering.

16. A web host service system for creating and customizing rich media contents at a centralized place, and rendering and presenting said rich media contents via Internet at geographically distributed places, comprising:
a client manager that facilitates the web users to create user accounts, maintain user profiles, access user accounts, and change account settings;
a rich media content template library that comprises a plurality of pre-designed rich media content templates; and
a rich media functional module that comprises a plurality of tools to edit, customize, upload, merge, and publish rich media contents.

17. The system of claim 16, further comprising distributed storage nodes that store web users' customized rich media content files, account setting data, personal profile data, and uploaded rich media content file.

18. The system of claim 17, wherein each of the distributed storage nodes comprises:
a storage manager to facilitate web users to connect and communicate with said storage nodes; and
a plurality of user account folders to store web users' customized rich media content files, account setting data, personal profile data, and uploaded rich media content file.

19. The system of claim 16, further comprising an engine that
searches files in rich media content template library and in users' account folders, and then returns and displays the search results; and
provides connection and protocol supports to respond the requests from remote websites or web users on fetching the data and files on said web host service system and deliver the data and files back to said remote websites or said web users.

20. The system of claim 16, wherein the pre-designed rich media content templates comprise:
visual media files with regard to icons and tags, animations, pictures, images, videos, digital albums, showcases, show rooms, show windows, and natural backgrounds or foregrounds;
acoustic media files with regard to various sound clips and tracks; and
combined visual media files and acoustic media files.

21. The system of claim 16, wherein the tools comprise:
a media browser that provides web users means to browse files in said rich media content template library or files in the account folders of said web users;
a media editor that provides web users means to edit files in said rich media content template library or files in the account folders of said web users;
a media uploader that provides web users means to upload personal media file into said web host service system;
a media combiner that provides web users means to merge said uploaded personal media files with selected files in said rich media content template library; and
a media publisher that provides web users to review and publish merged rich media contents, set permissions on the published rich media contents, and generate web address code and attributes codes for said published rich media contents.

22. The system of claim 21, wherein the permissions comprise private permission, limited permission and public permission based on the levels of access and the types of access that the owner of said published rich media contents wants to give to other web users.

23. The system of claim 21, wherein the web address code comprises at least a unique URL address, and wherein the attribute codes comprise at least one of a listing date, a listing user, a specification, a warranty, a manufacturer, a shipping method, a shipping rate, and a contact method with regard to said published rich media contents.

24. The system of claim 16, wherein the rich media functional module further comprises a tool of media recorder that provides means to record web users' operations on rich media content files and generate recording scripts that can be played later to automatically repeat said web users' operations on said rich media content files.

25. A web host service system for creating and customizing online stores and then listing published rich media contents in said online stores in said web host service system, comprising:
a client manager that facilitates web users to create user accounts, maintain user profiles, access user accounts, change account settings, and connect to storage nodes;
an online store template library that comprises a plurality of pre-designed online store web pages and configurations; and
an online store functional module that comprises tools to create, edit, customize, and upload web pages of the users' personal online stores.

26. The system of claim 25, further comprising distributed storage nodes that store the web users' account setting data, personal profile data, online store web page data, and online store setting data.

27. The system of claim 25, wherein each of the distributed storage nodes comprises:
a storage manager that facilitates the web users to connect and communicate with said storage nodes; and
a plurality of user account folders that store web users' account setting data, personal profile data, online store web page data, and online store setting data.

28. The system of claim 25, further comprising an engine that
searches files in said online store template library and in said users' account folders, and then returns and displays the search results; and
provides connection and protocol supports to respond the requests from remote websites and web users on fetching the data and files on said web host service system and deliver the data and files back to said remote websites and said web users.

29. The system of claim 25, wherein the pre-designed online storage template library comprises a plurality of pre-design web page templates and configurations for web users to quickly create personal online stores on said web host service system.

30. The system of claim 25, wherein the tools comprise at least an online store creator that provides web users the functions to:
browse, edit and customize the web page templates in said online store template library;
upload personal online store web pages into said web host service system; and
list and manage the published rich media contents and display the associated attributes of said published rich media contents in the web users' personal online stores.
